(19) United States
(12) Patent Application Publication
(10) Pub. No.: US 2018/0323991 A1
(43) Pub. Date: Nov. 8, 2018

(54) INITIALIZING MACHINE-CURATED SCENES

(71) Applicant: Essential Products, Inc., Palo Alto, CA (US)

(72) Inventors: Mara Clair Segal, San Francisco, CA (US); Manuel Roman, Sunnyvale, CA (US); Dwipal Desai, Palo Alto, CA (US); Andrew E. Rubin, Los Altos, CA (US)

(21) Appl. No.: 15/991,780

(22) Filed: May 29, 2018

Related U.S. Application Data
(63) Continuation-in-part of application No. 15/672,027, filed on Aug. 8, 2017.
Application No. 15/672,027 is a continuation-in-part of application No. 15/604,226, filed on May 24, 2017.
(60) Provisional application No. 62/512,633, filed on May 30, 2017.
(60) Provisional application No. 62/512,641, filed on May 30, 2017.
(60) Provisional application No. 62/503,251, filed on May 8, 2017.

(51) Int. Cl. H04L 12/28; G10L 15/26; G06F 3/01; G06F 3/0488

(52) U.S. Cl. CPC H04L 12/282; G06F 3/04883; G06F 3/017; G10L 15/265

(57) ABSTRACT

The present disclosure contemplates a variety of improved methods and systems for initializing a curated scene. The described solution includes a method comprising receiving a user instruction including a user intention to initialize a scene controlling the functionality of one or more devices within an environment, determining the scene associated with the user instruction, and performing the functionalities of the scene using an assistant device and the one or more devices within the environment that are capable of performing the activities.

### CLAIM FOR PRIORITY

This application claims priority to U.S. Provisional Patent Application No. 62/512,633, entitled “Initializing Machine-Curated Scenes,” and filed on May 30, 2017. In addition, this application is a continuation-in-part of U.S. patent application Ser. No. 15/672,027, entitled “Secure Machine-Curated Scenes,” and filed Aug. 8, 2017, which claims priority to U.S. Provisional Patent Application No. 62/512,641, entitled “Secure Machine-Curated Scenes,” and filed on May 30, 2017 and is a continuation-in-part of U.S. patent application Ser. No. 15/604,226, entitled “System and Method for Generating Machine-Curated Scenes,” and filed May 24, 2017, which claims priority to U.S. Provisional Patent Application No. 62/503,251, entitled “System and Method for Generating Machine-Curated Scenes,” and filed May 8, 2017. The content of the above-identified applications are incorporated herein by reference in their entirety.

### TECHNICAL FIELD

The present disclosure contemplates a variety of improved methods and systems to initialize machine curated scenes.

### BACKGROUND

The Internet of Things (IoT) allows for the internetworking of devices to exchange data among themselves to enable sophisticated functionality. For example, assistant devices configured for home automation can exchange data with other devices to allow for the control and automation of lighting, air conditioning systems, security, etc. Existing solutions require users to select individual devices and ascribe settings to them one-by-one, potentially within a menu format.

### SUMMARY

The present disclosure contemplates a variety of improved methods and systems for initiating a unique user experience using an ambient operating system connected to a variety of disparate devices. The described solution includes a curated scene or set of actions initiated by an assistant device. For example, the assistant device detects it is a weekday morning and initiates actions associated with a wakeup routine such as opening the blinds, making coffee, and notifying the user of the current traffic report. In at least one embodiment, the scenes include providing services or content available via the home device software or through third-party integration.

Some of the subject matter described herein includes a method for a home assistant device with artificial intelligence to initializing a curation of a scene in an environment, comprising: receiving, via a microphone and a camera, a user instruction from a user, the user instruction having a two or more of a user speech, user gesture, selection on the screen of an assistant device, selection on the screen of a device, a time, or an event indicating a user intention to initiate a scene including a functionality of one or more devices within an environment to be performed using the assistant device; identifying the scene trigger in the user instruction corresponding to the user intention to initiate the scene using a visual recognition algorithm and a speech recognition algorithm; determining the scene associated with the scene trigger in the user instruction; and transmitting a request to one or more devices associated with the scene to perform the functionality as defined in the scene associated with the scene trigger. A user instruction can include speech spoken by the user.

Some of the subject matter described herein includes a method for initializing the curation of a scene by an assistant device: receiving, via a camera and a microphone, a user instruction having the user identification information of a plurality of users and a user intention to implement a functionality, on one or more devices within the environment, to be performed using the assistant device; determining the one or more scenes associated with the user instruction, each scene having associated personalization settings identifying the one or more users permitted to initiate the scene and associated privacy settings, indicating the one or more users permitted to view the scene in the environment; determining that the user providing the user instruction is permitted to initiate the scene; determining the one or more adapters and the one or more devices in the environment associated with the scene; determining that the plurality of users are permitted to view the scene in the environment in accordance to the privacy settings; and transmitting one or more commands as specified in the one or more adapters to the one or more devices in the home environment, via the assistant device, with a request to perform the one or more functionalities associated with the scene indicated in the user instruction.

Some of the subject matter described herein includes a method comprising: receiving a user instruction including a user intention to initialize a scene controlling the functionality of one or more devices within an environment; determining, via a processor, the scene associated with the user instruction; and performing the functionalities of the scene using an assistant device and the one or more devices within the environment that are capable of performing the activities.

### BRIEF DESCRIPTION OF THE DRAWINGS

FIG. 1 illustrates an example of the scene curated by the assistant device;

FIG. 2 illustrates an embodiment of a scene setup initiated by the assistant device;

FIG. 3 demonstrates an example of personalized scenes;

FIG. 4 demonstrates an embodiment of scenes, including privacy features;

FIG. 5 demonstrates an embodiment of a scene initialization flowchart; and

FIG. 6 illustrates an embodiment of the assistant device, including a processor, memory, non-volatile memory, and an interface device.

### DETAILED DESCRIPTION

A home can include many different electronic devices capable of providing different functionalities for a user. For example, a person waking up in the morning might open her blinds, prepare some coffee with a coffee machine, turn on the television and switch it to a news channel, and read a current traffic report on her tablet providing details on her commute to work that morning. This means that the user has a routine in which the same functionalities of the devices in the environment of her home are expected to be performed at the same day and same time. Other times, the user might engage in some activity many times, but not at a routine schedule. For example, the user might have a movie night on a Thursday at 7:30 PM and then another movie night on a Saturday at 11:00 PM. However, movie night on the different days might involve similar functionalities to be performed by the devices in the home, such as dimming the lights in the living room, turning on the television and opening a streaming video application to play back a movie, and turn on the sound system to play back audio at a certain volume. The user can use these devices manually or request an assistant device within the home to control the corresponding devices to perform the functionalities.

As disclosed herein, the assistant device can be configured to cause devices to perform functionalities such as opening the blinds, preparing coffee with a coffee machine, turning on the television and switching it to a news channel, and reading the current traffic report to the user about her commute to work that morning. This configuration of causing devices to perform functionalities can be called a scene. The assistant device scenes can save a user time by automatically performing the routines instead of requiring the user to initiate the functionality of each device separately. Each scene can be initiated by a trigger such as a word, a set of words, physical gesture, an event or a combination thereof. In an example, the scene can be associated with a “trigger” such as a phrase (e.g., “movie night”) so that the user can recite the phrase for the assistant device to then control the various devices to perform the functionalities.

The disclosure describes methods, systems, and devices for an assistant device driven set of actions associated with scenes. Scenes can include events which occur throughout the day (e.g., bedtime, morning, movie night, etc.). Thus, users can use the disclosed features to customize their homes to create an automated home environment. The home environment can include any physical environment within the range of the assistant device, a short range wireless network, and/or a wireless network provided by or used by the assistant device.

An assistant device can be set up in a home environment to provide speech-based responses to a user's speech. In some embodiments, the devices connected to the assistant device can be associated with one or more of voice activatable commands, device categories, descriptive information, and activity types. The information associated with the one or more connected devices; such as voice activatable commands, device categories, device description, and activity types, can be stored in a database accessible to the assistant device. Furthermore, one or more adapters can be stored which allows the assistant device to operate the one or more devices. In at least one embodiment, the adapter can include a command instruction specific to the device and/or device functionality. In an embodiment, the users of the assistant device can control the connected devices via one or more of speech, physical gesture (e.g., mouthing ‘turn off’, moving the hand in a specific pattern, looking at the assistant device with a specific expression, by providing some physical action), and/or textual input. The devices can be connected to the assistant device using a short range wireless network and/or a wireless network. In at least one embodiment, the devices are connected to the assistant devices using one or more of LTE, LTE-Advanced, Wi-Fi, Bluetooth, ZigBee, EnOcean, personal area networks, TransferJet, Ultra-wideband, WiMAX, HiperMAN, Li-Fi and/or IR.

In at least embodiment, the assistant device has access to a database which stores a list of connected devices and one or more of the associated adapters, the activity types, device descriptions, and/or device categories. In an embodiment, during the setup of the connection between the assistant device and the one or more devices, one or more of the associated adapters, activity types, device descriptions, and/or device categories are identified and stored in the database. This information can then be accessible to the assistant device and used for controlling the devices via the assistant.

For example, a smart thermostat connected to the assistant device can be controlled by user instruction. Once the user provides the user instructions “assistant device, please set the temperature to 72 degrees on the thermostat”, the assistant device can identify voice activatable commands to control the functions of the thermostat that set temperature, increase heat, or decrease heat. The user operation of the device can include oral speech such as the user instruction “set the temperature to 72 degrees”, causing the assistant device to set the thermostat to 72 degrees.

The device description identified within the user instructions can indicate which device the user intends to control; the device description includes identifying information about the device. The assistant device can store device descriptions such as the device location, type, and/or color (e.g., kitchen, toaster, silver, etc.). In an example, the user provides the instruction, “turn on the Cuisinart coffee maker please.”

Oftentimes, a user may require multiple actions to be performed. For example, when a user wakes up, she may want the coffee to be made, the curtains to be opened, and the TV turned on to hear the traffic report. Instead of requiring the user to provide multiple instructions, the assistant device provides a functionality to the user allowing the user to request the performance of multiple activities with one trigger (e.g., alarm clock ringing, user instruction, etc.). In the instant example, a scene can be configured to open the curtains, make the coffee, and turn on the TV to the appropriate channel by a simple user instruction to the assistant device: “initiate morning scene.”

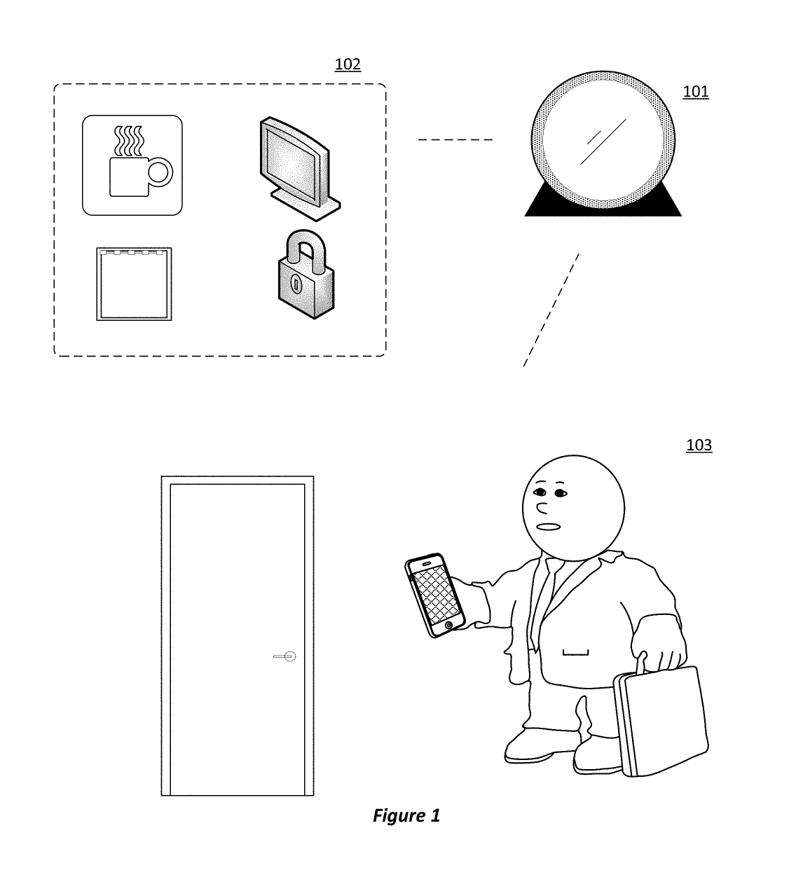

FIG. 1 illustrates an example of the scene curated by the assistant device 101. The scene in the example is the “home from work” scene. The activities of the “home from work” scene include making tea, turning on the television, opening curtains, and unlocking the front door. The devices 102 included in the scene can be an electronic tea kettle, television, motorized curtains, and a smart lock. In the example of FIG. 1, the trigger which causes the scene to be initiated is the user 103 entering the range of the home environment. The assistant device can identify that a user is home by identifying the devices which the user carries in the vicinity of the home environment such as the user's mobile phone, fitness device, an e-reader, and/or tablet. Based on the recognition of the user's devices which were not previously found in the environment, the assistant device can determine that a user is home from work. In the embodiment described in the example, the assistant device can determine that the user is approaching the front door. The location of the user can be calculated using the short range wireless network and/or a wireless network.

In at least one embodiment, the position of the user and/or the user's devices can be determined using an indoor positioning system (IPS). The indoor positioning system can determine location using three independent or more independent measurements. In at least one embodiment, the assistant device can determine the location of the user or user's devices using a Wi-Fi based positioning system (WPS). The user and/or device can be approximated using Bluetooth. The angle of the arrival of the signal can also be used to determine that the user and/or user's devices are approaching the entrance to the house. Other techniques used to determine location can include received signal strength indication and/or time of arrival.

Once the event of user 103 approaching the door is determined, the assistant device 101 can initiate the scene. The assistant device can send instructions to the devices to perform the activities designated in the scene such as boiling water for tea, turning on the TV, opening curtains, and unlocking the front door smart lock.

Scenes can be created by user initiated setup process and/or by assistant device initiated setup. In at least one embodiment, the user can initiate the setup of a scene by providing instructions to the assistant device. The user can instruct the assistant device to create a scene by selecting devices, actions to be performed (e.g., functionalities such as turn on, turn off) and the trigger (e.g., word or set of words to activate the scene, a gesture, an event, etc.). The user can create the scene using the display of the assistant device to provide the instructions, via verbal input, via connected device (e.g., phone), and/or physical gesture (e.g., pointing at a device, sign language, etc.). For example, the user can provide the instructions “assistant device, I would like to setup a morning scene, can you help me?” In response, the assistant device can reply with “yes, I am happy to help you set up the morning scene. What activities should be associated with this scene?” The user can respond “the morning scene should include making coffee, opening the curtains in my bedroom and providing me with the traffic report.” In response, the assistant device can ask for clarification on some of the activities or create the scene.

In at least one example, the scene setup can include the user pointing at one or more devices the user can point to the device. For example, the user can instruct the assistant device “I would like to setup a morning scene, can you help me?” In response, the assistant device can reply with “Yes. What activities should be associated with this scene?” The user can respond “the morning scene needs to include the traffic report and opening those curtains” while pointing at a specific window. The assistant device can use a visual recognition algorithm to determine whether the user is point then assistant device can ask for clarification on some of the activities or create the scene. In at least one embodiment the assistant device can access a database and/or a table storing information associated with gestures and the related devices.

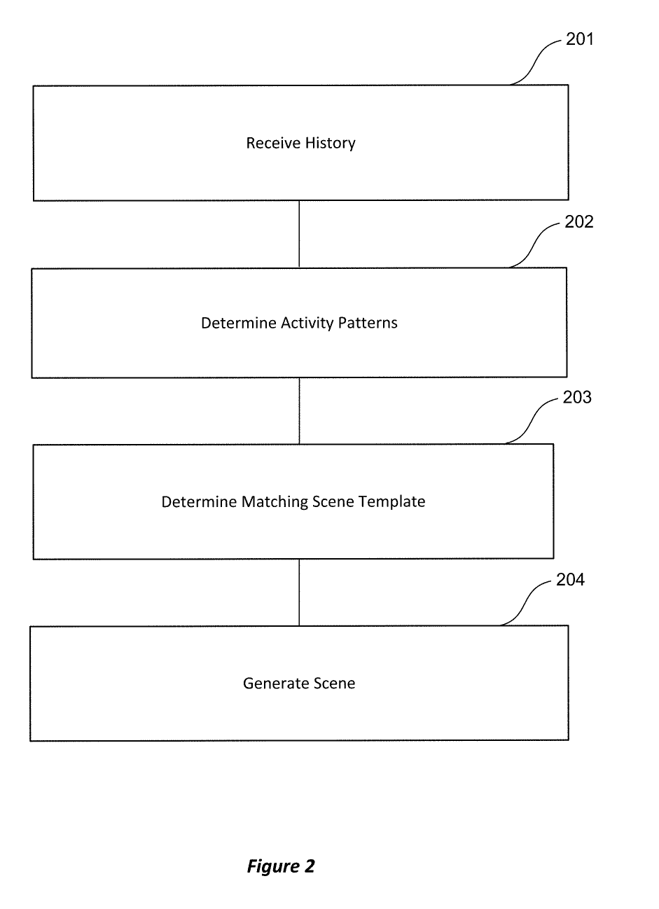

FIG. 2 illustrates an embodiment of scene setup initiated by the assistant device. Activity patterns 202 can be determined by analyzing the history 201. History 201 can include activities such as user interaction with devices in the home environment and/or other use information. For example, history 201 can include a user turning off the lights manually, turning off the lights via a device such as a smart phone, and/or requesting the assistant device to turn off the lights. Other examples of history 201 can include a user opening the garage door, arming the security system, closing curtains, turning off an alarm clock, making coffee, adjusting the temperature on the thermostat, etc.

The history 201 can be analyzed by one or more machine learning algorithms. The machine learning algorithms can include one or more of decision tree learning, association rule learning, artificial neural networks, deep learning, inductive logic programming, support vector machines, clustering, Bayesian networks, reinforcement learning, representation learning, similarity and metric learning, sparse dictionary learning, genetic algorithms, rule-based machine learning, learning classifier systems, supervised learning, unsupervised learning, semi-supervised learning, clustering algorithm, and/or classification algorithm. In at least one embodiment, external information is used to determine activity patterns. External information can include calendar information, weather, news, and social media.

In at least one embodiment, the history 201 can be used to identify activities and activity patterns. For example, it can be determined that the daily events or activities of a user such as opening the IoT curtains, turning on the bathroom light, using the electronic toothbrush, and turning on the coffee machine within a 20-minute window are related activities. Using calendar information, it can further be determined that the related activity pattern only occurs on weekday mornings. The activity pattern can be determined using a fuzzy matching algorithm. An activity pattern can be determined when the match is less than perfect. In at least one embodiment, a match threshold can be set.

In another example, it can be determined that turning the television on in the evening, dimming the lights, and making popcorn are related activities. In the example, the related activities do not occur on a scheduled interval and therefore can be determined to be related activities based on a match threshold.

In at least one embodiment, the activity pattern 202 is determined using data from multiple users. In some embodiments, the activity pattern 202 is determined specific to individual users. In at least one embodiment, activity initiated by multiple users and determined to be related can be used to determine an activity pattern 202. In at least one embodiment, the activity is determined to be related when the users interact with each other in temporal proximity to their respective actions. For example, if two users are talking and then a minute later one user performs the action of turning off the lights and the other user performs the activity of making popcorn, then these two actions can be determined to be related and identified as an activity pattern 202.

In at least one embodiment, entries from one or more calendars are used to determine details about related activities and can be used to identify the scene. For example, when it is determined that the TV is turned on in the evening, the lights are turned off and popcorn is made are related activities, and the user's calendar can be reviewed for calendar entries and can be matched. In the example, it can be identified that user has a calendar entry marked “watched football game” in a temporal proximity to the related activity. In at least one embodiment, the matching of calendar entries to related activities can include identifying participants in the calendar entry and comparing it to the participants in the related activity set.

Once the related activity is identified, it can be used to create a scene. A scene can include one or more actions and/or a set of actions. The actions can include the functionalities and behavior of devices and the assistant device. For example, a set of actions in a “bedtime” scene can include turning off the lights, arming the security system, and locking the deadbolt. Scenes can be initiated by a scene trigger or combination of triggers including a verbal command, a user gesture, selecting the scene on the screen of the assistant device or connected device (e.g., phone), a set of actions, a scheduled time, or an event (e.g., alarm clock ringing, visitor at the door, etc.). If the “bedtime” scene is configured, the user can state “assistant device, it's bedtime.” In response to the user instruction, the assistant device can initiate the set of actions associated with the “bedtime” scene which can include turning off the lights, arming the security system, and locking the deadbolt. In another example, the user can instruct the assistant device via a physical gesture such as signing “bedtime” using American Sign Language and/or mouthing the word. This physical gesture can be set as a scene trigger and cause the assistant device to initiate the set of actions (e.g., user performing certain actions like turning off the light, and the television in the evening) associated with “bedtime.” The trigger for the “bedtime” scene can also be a set of actions such as all users in the home environment going to sleep. In at least one embodiment the assistant device can access a database and/or a table storing one or more triggers including a speech, verbal command, a user gesture, selecting the scene on the screen of the assistant device or connected device (e.g., phone), a set of actions, a scheduled time, or an event (e.g., alarm clock ringing, visitor at the door, etc.).

The assistant device can monitor activity, and when an activity pattern occurs a threshold number of times (e.g., 5 times per week, 2 times per day, 2 times per month, etc.), the assistant device either prompts the user to set up the scene and/or automatically generates the scene 204. The threshold can be preconfigured. In at least one embodiment, the threshold can be adjusted based on the user. Users can have associated user profiles, and the user profiles can include a patience metric. The patience metric can measure the user's capacity to tolerate system error and/or delay. For example, a user who frequently uses an angry tone, angry words, and frustrated gestures can have a low patience metric, and therefore the activity pattern match threshold can be set to higher than the system default. In at least one embodiment, each user is associated with a default patience threshold, which is adjusted based on that user's behavior over time.

In an embodiment the activity pattern is matched against a scene template 203, and once a match is determined the scene can be generated. A scene template can include a plurality of elements. Each element can include one or more of activity types and/or device categories. In the “bedtime” scene example, the “bedtime” scene template can include an element with an activity type of control lights and the device category “lights” and another element with an activity type “security” and the device category “security system.” Other scene templates can exist including “wakeup routine,” “movie night,” “kids are sleeping,” and “work from home” templates.

Each template can have predefined elements associated with the unique scene. Each template can include unique elements typical to the unique scene. In an example, the “kids are sleeping” scene template can include activity types “communication” and “illumination” and device categories “phone” and “lights.” In at least one embodiment, the elements can include a location, time of day (e.g., morning, 12-2 pm, lunch time, etc.), and/or demographic information. For example, the “move night” scene template can include an element which has an activity type “illumination,” device category “lights,” time “evening,” and location “living room.”

The demographic information can be information about a user's likeliness to have activity patterns that match. For example, the use demographic information of a “playtime” scene template could be set to child user. The demographic information can include any unique information about a particular group such as adult, woman, man, child, young adult, parent, student, doctor, lawyer, etc.

The assistant device can have popular scene templates stored in local resources. The scene templates can be matched to the activity pattern 202 to generate a customized scene for the home environment. The activity pattern 202 can be analyzed to determine the activity, activity type, the device, the device category, time, calendar day, and/or location of each activity. The activity pattern can be matched against scene templates. The matching can be accomplished using one or more data matching algorithms. The matching algorithms can include calculating a match score. In at least one embodiment, fuzzy matching is used to determine a match.

In at least one embodiment, a match is less than 100% perfect. The imperfect match can include a present threshold which is preset for all scene templates. In at least one embodiment, each scene template is associated with a threshold for a match. The number of elements associated with a scene template can be correlated to the threshold amount. For example, a scene template with seven elements can be associated with a lower match threshold than a scene template with two elements. In another example, a scene template with seven elements can be associated with a higher match threshold requirement than a scene template with two elements. In at least one embodiment, the matching includes the weighted relevance of each potential matching factor. For example, the demographic information can have a very low weight. Thus, a man performing a set of actions identified in the scene template as young adult demographic activity would still yield a match.

In at least one embodiment, the match threshold can be adjusted based on the user. Users can have associated user profiles; the user profiles can include a patience metric. The patience metric can measure the user's capacity to tolerate system error and/or delay. For example, a user who frequently uses an angry tone, angry words, and frustrated gestures can have a low patience metric and therefore the scene template match threshold can be set to higher than the system default. In at least one embodiment, each user is associated with a default patience threshold, which is adjusted based on that user's behavior over time.

Once an activity pattern is determined to match a scene template, the assistant device can create a customized scene for the user. In an embodiment, once an activity pattern and scene template are found to match, the customized scene is created automatically, and the assistant device can notify the user that it has been created. For example, when it is identified that the user has engaged in an activity pattern (e.g., open curtains, make coffee, turn on news) which matches the “good morning” scene template, the assistant device can tell the user “I noticed you have a morning activity pattern; I've created a scene which allows for the activities to be performed automatically. You just need to say ‘initiate good morning scene.’ I can also set up a different scene trigger if you'd like.”

In at least one embodiment, the assistant device can prompt the user to set up the customized scene. After detecting an activity pattern and determining a matching scene template 203, the assistant device can prompt the user “I noticed you have a repeating morning activity pattern; would you like me to set it up so that you can perform all the actions with one trigger?” In the example, if a user responds ‘yes,’ the assistant device can automatically set up the customized theme, and the assistant device can further allow users to add activities and a trigger to the customized scene. For example, the assistant device can add an activity of starting the car and opening the garage door to the weekday morning routine. The assistant device can further allow the user to customize the trigger, including having the trigger set to an event (e.g., an alarm clock ringing, etc.).

In at least one embodiment, when a device is newly connected, the assistant device may provide an option to add the device to an existing scene. The device type, activity type and/or location of the newly connected device can be determined to match the elements of the scene template associated with a scene. Once the match is determined, the assistant device can provide an option for the user to add the newly connected device to an existing scene. For example, if a new curtain device is installed in the bedroom, the assistant device can determine that it is an element of a scene template associated with the “morning” scene and prompt the user to add the curtain device to the scene.

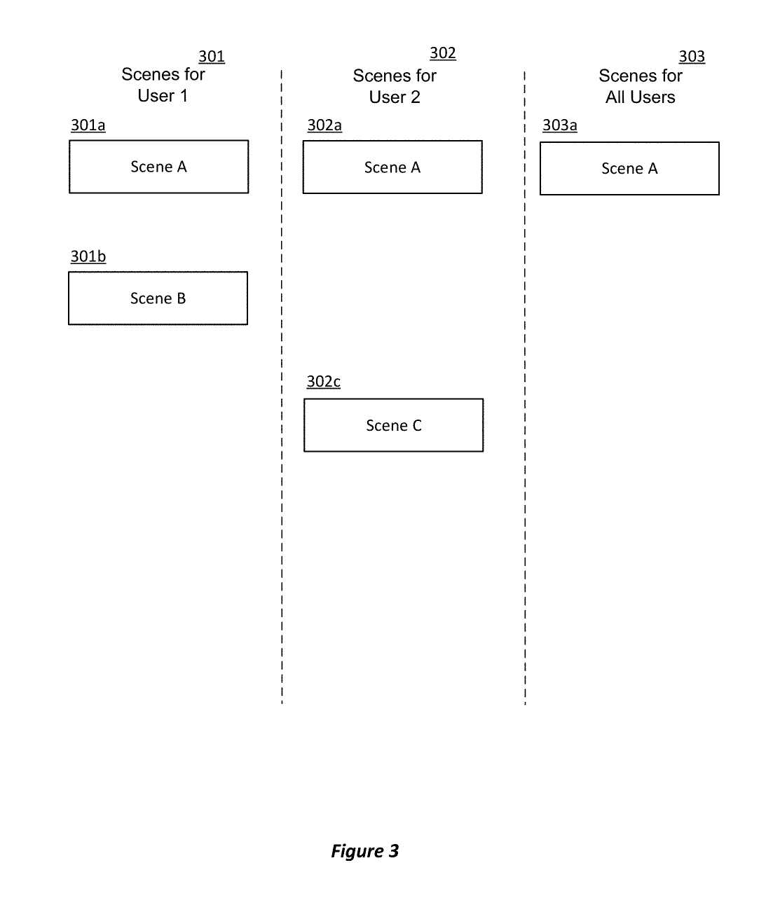

Scenes can be user specific. The “welcome home” scene described in FIG. 1 may not be the same for two different users. FIG. 3 demonstrates an example of a user specific scene. A scene can be associated with specific users or groups of specific users. During the setup of a scene, a user may be prompted personalize the scene by identifying whether the scene is personal to a user, a group of users, or for all users. An example of a personal scene can include a user specific “morning” scene which can include a music playlist or a list of the user's meetings for the day. A “family came home” scene can be a group specific scene. Alternatively, certain scenes can be associated with all users such as a “secure the house” scene. User 1 301 can be associated with scenes A 301a and B 301b. While user 2 302 can be associated with scenes A 302a and C 302c. Scene A 303a can be associated all users of the assistant device.

Users of the assistant device can have associated user profiles. The user profiles can include information that can be used to identify a user such as devices worn by the user and/or biometric information. In an embodiment, during the scene setup an associated user can be identified. The associated user can be identified by the user setting up the scene. In at least one embodiment, the assistant device can suggest the user or group of users.

The assistant device can determine the associated users to suggest by analyzing the history 201. In an embodiment, the analysis of the history can include machine learning algorithms. The machine learning algorithms can include one or more of decision tree learning, association rule learning, artificial neural networks, deep learning, inductive logic programming, support vector machines, clustering, Bayesian networks, reinforcement learning, representation learning, similarity and metric learning, sparse dictionary learning, genetic algorithms, rule-based machine learning, learning classifier systems, supervised learning, unsupervised learning, semi-supervised learning, clustering algorithm, and/or classification algorithm.

The assistant device can identify users. User identification can include one or more of voice biometrics, speaker recognition (e.g., speech pattern recognition, etc.), finger print verification, biometric facial recognition, ear identification, heartbeat identification, or identifying users by devices typically found on the user (e.g. wearable devices, phones, etc.). The assistant device can use text, touch, audio and video input to identify a user or a plurality of users. The text, touch, audio and/or video input can be compared against the biometric information of users in association with user profiles to determine one or more users. In at least one embodiment, the biometric information is stored in the local storage (e.g., hard drive of assistant device, memory of connected device, etc.) and/or in the remote storage (e.g., cloud, etc.).

In at least one embodiment, during scene setup, the user can be asked “is this a personalized scene unique to you? Is it unique to a group?” The user can respond, “no this scene is for everyone.” Based on this response, the assistant device can configure the scene to be available for everyone. Scene A 301a, 302a and 303a is an example of a scene available for all users 303, including user 1 301 and user 2 302.

In at least one embodiment, during scene setup, the user can be asked “is this a personalized scene unique to you? Is it unique to a group?” The user can respond “yes, this scene is personal to me.” Based on the response, the assistant device can configure the scene 301b to be associated to a specific user 301. In an embodiment, scenes that are configured as unique to a specific user may only be accessed by that specific user. For example, when user 1 provides the instructions “assistant device, please initiate scene c,” in response the assistant device can respond “I am sorry user 1, only user 2 is configured to use scene c. Would you like to setup scene c?” If a user responds “yes,” the assistant device can walk the user through the setup process. The assistant device may store two different scene c, each in association with the unique user. In at least one embodiment, the assistant device may require the second version of scene c to have an alternative name such as scene c2. In at least one embodiment, instead of setting up a new scene c for user 1, the assistant device can update the personalization settings on the original scene c 302c and give access to user 1 301 to use scene c 302c.

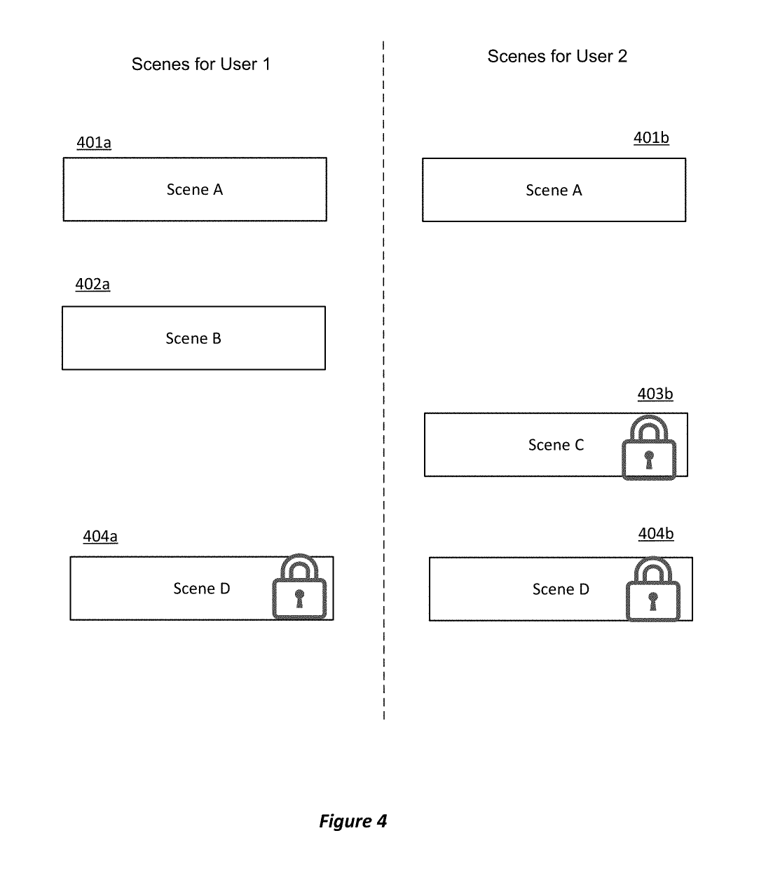

Some scenes can be embarrassing to the users, for example, a user who lives alone can be ashamed if a guest spending the night hears the music playlist of his morning scene. FIG. 4 demonstrates an embodiment of scenes including privacy features. The scenes can include privacy features, for example, scene C 403b is private to user 2. At scene setup, the assistant device can ask the user to set up the privacy information associated with the scene.

In at least one embodiment, the assistant device identifies whether the scene includes potentially embarrassing or private activities. The potentially embarrassing activities can be determined using machine learning. In at least one embodiment, certain activities such as music playlists, activities involving a camera, and/or activities involving delivering information from a personal device (e.g., reading meeting for the day from the user's phone calendar, reading newly received text messages, etc.) can be flagged as potentially embarrassing or private.

In an embodiment, during the setup of the scene the assistant device can determine a potentially embarrassing or private activity and prompt the user with an option to add a privacy setting to the scene. For example, during the setup of scene c 403, the assistant device can prompt user 2 “I noticed you have potentially private activities in this scene, would you like to add security settings?” The user can respond with “yes, please make this scene private.” Once the user indicates the scene is private, the assistant device can set the privacy settings on the scene to only be curated when the user is alone.

Furthermore, in at least one embodiment, once a scene is identified as private, the assistant device can adjust the personalization settings on the scene so only the user that set up the scene can access it. In at least one embodiment, where the scene (e.g. scene d 404a and 404b) is accessible by multiple users and indicated as private, the scene can be configured to be initiated only by the users to whom the scene is personalized (e.g., user 1 and 2) and only curated when those users are not in the company of other users who do not have access to the scene.

In at least one embodiment, the assistant device does not provide the option for the privacy of a scene unless the user specifically requests it. In an embodiment, the assistant device asks the user at scene setup whether the user would like to add a privacy setting on the scene. In at least one embodiment, the user of the assistant device can edit the scene settings, the personalization settings, and/or the privacy settings during setup and/or after setup.

In an example, a user setting up the assistant device can personalize a scene but decline to add security. For example, user 1 can setup scene b 402a to be personalized only to him but not indicate the scene as private. In other words, only user 1 will be able to initialize the curation of scene b. User 1 will be able to initialize scene b 402a if user 2 is detected because there are no privacy restrictions on scene b 402a. However, user 2 will not be able to initialize scene c 403b if user 1 is detected because scene c 402c is set as private.

In an example, a user setting up scene a 401a and 401b can set the personalization settings for scene a to include user 1 and user 2. An assistant device can ask the user “would you like to set the privacy settings on scene a”, and in response the user can answer “no.” Because the user 1 chose not to set privacy settings on scene a, it can be initialized by either user 1 or user 2 in front of any detected user.

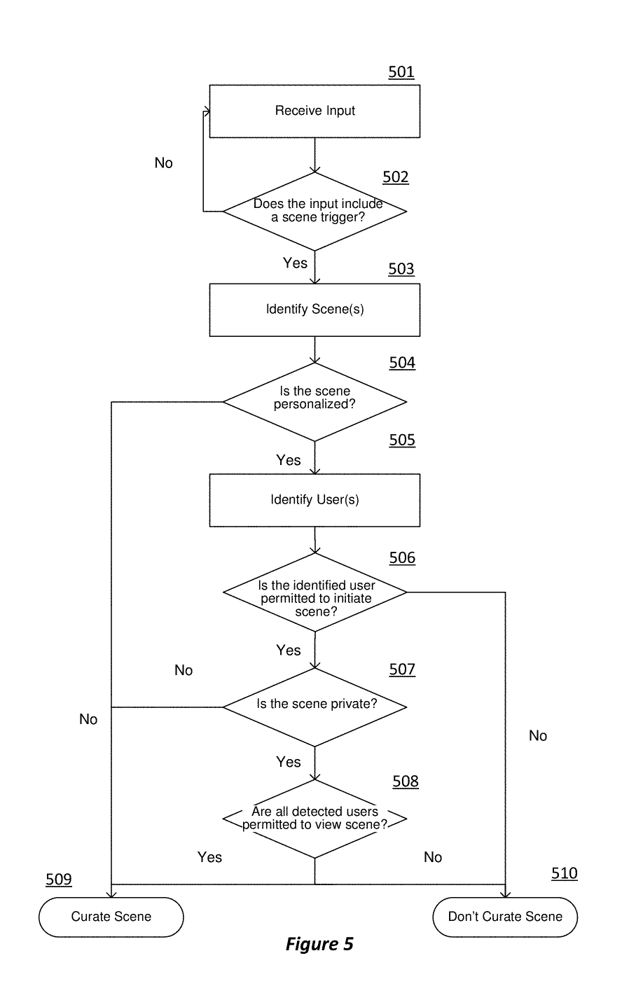

FIG. 5 demonstrates an embodiment of a scene being initialized. At block 501, an input such as a user instruction is received. The input can include one or more of audio, visual and/or signal. The assistant device can determine 502 whether the input includes a scene trigger. A scene trigger can be one or more audio, visual and/or signals which are configured to initiate a scene. For example, the “morning” scene can be set to be triggered by an event of an alarm of an alarm clock. In an embodiment, a scene can be triggered by an event such a specific time (e.g., 7 am PST, etc.), a set of activities (e.g., all users in the environment and in their bedrooms), the presence of a device (e.g., identify user device in the environment), a textual input such as a command from device (e.g., phone sending command to initiate scene, etc.), and/or a command entered on the assistant device (e.g., user selects scene from menu on assistant device screen, etc.). In at least one embodiment, a trigger is initiated by an app stored on a connected device.

In an example, the trigger can be set to a physical gesture such as a mouthing of a word, moving the hand in a specific pattern, a facial expression, and/or any other physical action. The physical gesture can be identified by the visual input from a camera of an assistant device and/or a connected device. For example, the trigger for the “good night” scene can be set to a user looking at the assistant device and mouthing the words “good night.”

In another example, the trigger can be set to a verbal command. For example, the trigger for the “night” scene can be set to the verbal command “prepare the house for sleep.” In at least one embodiment, a scene can be associated with multiple triggers and/or a combination of triggers.

Once a trigger is received, the assistant device can identify one or more associated scenes 503. The scene information can be stored in a database, and the database can be stored in the local storage (e.g., assistant device, device connected to assistant device, etc.) and/or the remote storage (e.g., cloud, etc.). It can further be determined whether the identified one or more scenes are personalized 504. In an embodiment, when the one or more scenes are determined to be personalized, the assistant device can identify the one or more users in the home or the one or more users providing the input 505 then determine whether one or more of the identified users is associated with the one or more scenes.

If multiple scenes are identified by the trigger and the identifying user information, the assistant device can ask the user for clarification on which scene should be performed. For example, if two scenes entitled “good morning” exist, each associated with a different user (user A and user B), and the assistant device identifies both user A and user B in the home however cannot determine which user caused the trigger, then the assistant device can ask the users “there are two good morning scenes, would you like me to curate the scene associated with user A or the scene associated with user B.” Based on the user response the assistant device can identify the scene.

In an embodiment, once the scene is identified, a determination is made as to whether it is a private scene 507. A private scene includes scenes that are configured to not be performed in presence of other users which are not identified in the settings. For example, “morning” scene can have associated settings which limit only users A and B to be present during the curation. If user C is detected in the environment, the assistant device can determine that the scene cannot be curated 510.

In at least one embodiment, during the curation of a private scene the assistant device can monitor for unpermitted users and terminate the curation of the scene if an unpermitted user is identified in the environment. For example, “morning” scene can have associated settings which limit only users A and B to be present during the curation. The device can determine that only user A is in the environment at the time 508 of the initiation of the scene and curate the scene 509. The assistant device can continue to monitor the environment, and once user C is detected in the environment the assistant device can determine that the scene cannot be curated 510 and terminate the curation of the scene.

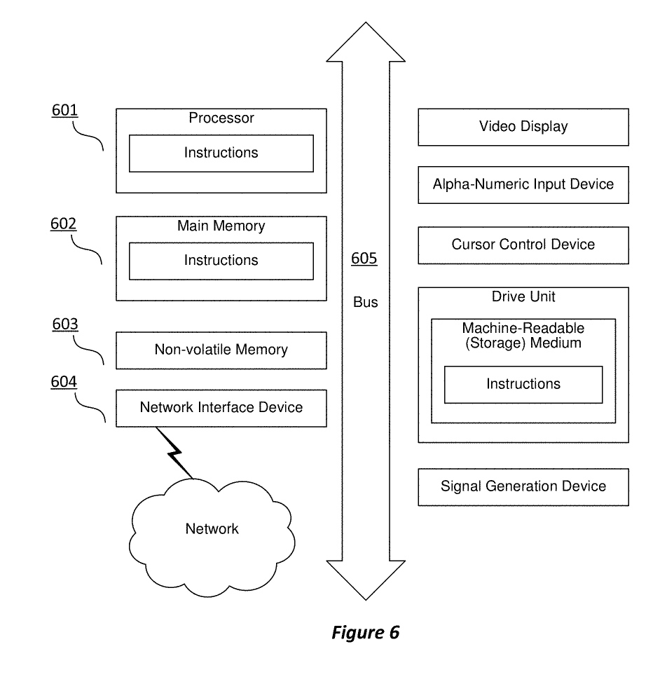

In FIG. 6, the assistant device includes a processor 601, memory 602, non-volatile memory 603, and an interface device 604. Various common components (e.g., cache memory) are omitted for illustrative simplicity. The assistant device is intended to illustrate a hardware device on which any of the components described in the example of FIGS. 1-5 (and any other components described in this specification) can be implemented. The components of the assistant device can be coupled together via a bus 605 or through some other known or convenient device.

In at least one embodiment, the assistant device can be operated using an ambient operating system such as a meta-operating system targeted at IoT and ubiquitous computing scenarios. Ambient OSes orchestrate ambient resources and provide a set of abstractions and APIs which simplify the development of dynamic ambient-oriented services and applications that span the reach of a single device.

The processor 601 may be, for example, a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory 602 is coupled to the processor by, for example, a bus. The memory can include, by way of example but not limitation, random access memory (RAM), such as dynamic RAM (DRAM) and static RAM (SRAM). The memory can be local, remote, or distributed.

The bus 605 also couples the processor 601 to the non-volatile memory 603 and drive unit. The non-volatile memory 603 is often a magnetic floppy or hard disk; a magnetic-optical disk; an optical disk; a read-only memory (ROM) such as a CD-ROM, EPROM, or EEPROM; a magnetic or optical card; or another form of storage for large amounts of data. Some of this data is often written, by a direct memory access process, into memory during the execution of software in the computer. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

The software is typically stored in the non-volatile memory 603 and/or the drive unit. Indeed, storing an entire large program in memory may not even be possible. Nevertheless, it should be understood that for software to run, it may be necessary to move the software to a computer-readable location appropriate for processing, and, for illustrative purposes, that location is referred to as memory in this application. Even when software is moved to memory for execution, the processor will typically make use of hardware registers to store values associated with the software and make use of a local cache that, ideally, serves to accelerate execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

The bus 605 also couples the processor to the network interface device. The interface can include one or more of a modem or network interface. Those skilled in the art will appreciate that a modem or network interface can be considered to be part of the computer system. The interface can include an analog modem, an ISDN modem, a cable modem, a token ring interface, a satellite transmission interface (e.g., “direct PC”), or other interface for coupling a computer system to other computer systems. The interface can include one or more input and/or output devices. The input and/or output devices can include, by way of example but not limitation, a keyboard, a mouse or other pointing device, disk drives, printers, a scanner, and other input and/or output devices, including a display device. The display device can include, by way of example but not limitation, a cathode ray tube (CRT), a liquid crystal display (LCD), or some other applicable known or convenient display device. For simplicity, it is assumed that controllers of any devices not depicted in the example of FIG. 6 reside in the interface.

In operation, the assistant device can be controlled by operating system software that includes a file management system, such as a disk operating system. The file management system is typically stored in the non-volatile memory and/or drive unit and causes the processor to execute the various acts required by the operating system to input and output data, and to store data in the memory, including storing files on the non-volatile memory and/or drive unit.

Some items of the detailed description may be presented in terms of algorithms and symbolic representations of operations on data bits within a computer's memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electronic or magnetic signals capable of being stored, transferred, combined, compared, and/or otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, those skilled in the art will appreciate that throughout the description, discussions utilizing terms such as “processing” or “computing” or “calculating” or “determining” or “displaying” or “generating” or the like refer to the action and processes of a computer system or similar electronic computing device that manipulates and transforms data represented as physical (electronic) quantities within the computer system's registers and memories into other data similarly represented as physical quantities within the computer system's memories or registers or other such information storage, transmission, or display devices.

The algorithms and displays presented herein are not inherently related to any particular computer or other apparatus. Various general-purpose systems may be used with programs in accordance with the teachings herein, or it may prove convenient to construct more specialized apparatuses to perform the methods of some embodiments. The required structure for a variety of these systems will be apparent from the description below. In addition, the techniques are not described with reference to any particular programming language, and various embodiments may thus be implemented using a variety of programming languages.

In further embodiments, the assistant device operates as a standalone device or may be connected (e.g., networked) to other machines. In a networked deployment, the assistant device may operate in the capacity of a server or of a client machine in a client-server network environment or may operate as a peer machine in a peer-to-peer (or distributed) network environment.

In some embodiments, the assistant devices include a machine-readable medium. While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database and/or associated caches and servers) that store the one or more sets of instructions. The term “machine-readable medium” and “machine-readable storage medium” should also be taken to include any medium that is capable of storing, encoding, or carrying a set of instructions for execution by the machine, and which causes the machine to perform any one or more of the methodologies or modules of the presently disclosed technique and innovation.

In general, the routines executed to implement the embodiments of the disclosure may be implemented as part of an operating system or a specific application, component, program, object, module, or sequence of instructions referred to as “computer programs.” The computer programs typically comprise one or more instructions set at various times in various memory and storage devices in a computer that, when read and executed by one or more processing units or processors in a computer, cause the computer to perform operations to execute elements involving various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally, regardless of the particular type of machine- or computer-readable media used to actually effect the distribution.

Further examples of machine-readable storage media, machine-readable media, or computer-readable (storage) media include, but are not limited to, recordable type media such as volatile and non-volatile memory devices, floppy and other removable disks, hard disk drives, optical disks (e.g., Compact Disc Read-Only Memory (CD-ROMS), Digital Versatile Discs, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, this may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice-versa. The foregoing is not intended to be an exhaustive list in which a change in state for a binary one to a binary zero or vice-versa in a memory device may comprise a transformation, such as a physical transformation. Rather, the foregoing is intended as illustrative examples.

A storage medium may typically be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe certain principles and practical applications, thereby enabling others skilled in the relevant art to understand the subject matter, the various embodiments and the various modifications that are suited to the particular uses contemplated.

While embodiments have been described in the context of fully functioning computers and computer systems, those skilled in the art will appreciate that the various embodiments are capable of being distributed as a program product in a variety of forms and that the disclosure applies equally regardless of the particular type of machine- or computer-readable media used to actually effect the distribution.

Although the above Detailed Description describes certain embodiments and the best mode contemplated, no matter how detailed the above appears in text, the embodiments can be practiced in many ways. Details of the systems and methods may vary considerably in their implementation details while still being encompassed by the specification. As noted above, particular terminology used when describing certain features or aspects of various embodiments should not be taken to imply that the terminology is being redefined herein to be restricted to any specific characteristics, features, or aspects of the disclosed technique with which that terminology is associated. In general, the terms used in the following claims should not be construed to limit the disclosure to the specific embodiments disclosed in the specification, unless those terms are explicitly defined herein. Accordingly, the actual scope of the technique encompasses not only the disclosed embodiments but also all equivalent ways of practicing or implementing the embodiments under the claims.

The language used in the specification has been principally selected for readability and instructional purposes, and it may not have been selected to delineate or circumscribe the inventive subject matter. It is therefore intended that the scope of the technique be limited not by this Detailed Description, but rather by any claims that issue on an application based hereon. Accordingly, the disclosure of various embodiments is intended to be illustrative, but not limiting, of the scope of the embodiments, which is set forth in the following claims.

From the foregoing, it will be appreciated that specific embodiments of the invention have been described herein for purposes of illustration, but that various modifications may be made without deviating from the scope of the invention. Accordingly, the invention is not limited except as by the appended claims.

I/We claim:

1. A method for an assistant device within an environment to implement an initialization of a functionality provided by one or more devices in response to a user's request, comprising:
receiving, via a processor, an audio data corresponding to a spoken speech within the environment, the spoken speech representing a user intention to initiate a scene including the functionality of the one or more devices within the environment to be manifested using the assistant device;
receiving an image data depicting a physical gesture of a user corresponding to a time of the spoken speech, the physical gesture representing the user intention to initiate the scene including the functionality of the one or more devices within the environment to be manifested using the assistant device;
determining a scene trigger using the audio data and the image data, the scene having the functionality of the one or more devices within the environment to be manifested using the assistant device;
identifying the one or more devices within the environment corresponding to the scene associated with the scene trigger; and
transmitting a request to the one or more devices associated with the scene to perform the functionality as defined in the scene associated with the scene trigger, the one or more devices communicatively coupled with the assistant device via a wireless local area network (WLAN) in the environment.

2. A method comprising:
receiving, via a processor, a user instruction representing a user intention to initiate a scene from a user, the scene representing a functionality of one or more devices within an environment to be performed using an assistant device;
identifying, via the processor, a scene trigger in the user instruction, the scene trigger corresponding to the user intention to initiate the scene;
determining, via the processor, the scene associated with the scene trigger, the scene representing the one or more devices in the environment and the functionality associated with associated the one or more devices within the environment to be performed using the assistant device in the environment; and
transmitting a request to the one or more devices associated with the scene to perform the functionality as defined in the scene associated with the scene trigger.

3. The method of claim 2, wherein the user instruction includes two or more of a user speech, a physical gesture, selection on a screen of the assistant device, selection on the screen of a device, a time, or an event indicating the user intention to initiate the scene.

4. The method of claim 2, wherein the user instruction includes an event that a user device entered the environment and wherein the scene trigger is the event.

5. The method of claim 2, wherein the user instruction includes a physical gesture, and verbal instruction of a plurality of users.

6. The method of claim 2, wherein identifying the scene trigger in the user instruction includes the step of requesting additional information from the user then using the additional information and the user instruction to identify the scene trigger.

7. The method of claim 2, wherein determining the scene associated with the scene trigger includes identifying the user providing the user instruction and determining the user is permitted to initiate the scene.

8. The method of claim 2, wherein transmitting the request to the one or more devices associated with the scene to perform the functionality as defined in the scene associated with the scene trigger includes determining the one or more devices associated with the scene are connected to the assistant device.

9. The method of claim 7, wherein identifying the user providing the user instruction includes a visual recognition algorithm.

10. The method of claim 9, wherein identifying the user includes identifying a user profile corresponding to the user.

11. The method of claim 3, wherein the scene trigger includes a combination of user speech and physical gesture.

12. An electronic device, comprising:
one or more processors;
a database including information regarding one or more devices in an environment; and
memory storing instructions, wherein the one or more processors are configured to execute the instructions such that the one or more processors and memory are configured to:
receive a user instruction representing a user intention to initiate a scene from a user, the scene representing a functionality of the one or more devices within the environment to be performed using an assistant device;
identify a scene trigger in the user instruction, the scene trigger corresponding to the user intention to initiate the scene;
identify the scene in the database associated with the information regarding the one or more devices in the environment associated with the scene trigger; and
provide a request to the one or more devices in the environment associated with the scene to perform the functionality of the one or more devices within the environment associated with the scene trigger.

13. The electronic device of claim 12, wherein the scene comprises the user instruction includes two or more of a user speech, a physical gesture, selection on a screen of the assistant device, selection on the screen of a device, a time, or an event indicating the user intention to initiate the scene.

14. The electronic device of claim 12, wherein the user instruction includes an event that a user device entered the environment and wherein the scene trigger is the event.

15. The electronic device of claim 12, wherein the user instruction includes a physical gesture, and verbal instruction of a plurality of users.

16. The electronic device of claim 12, wherein identification of the scene trigger in the user instruction includes requesting an input from the user then using the input and the user instruction to identify the scene trigger.

17. The electronic device of claim 12, wherein identifying the scene trigger includes identifying the user providing the user instruction and determining the user is permitted to initiate the scene.

18. The electronic device of claim 12, wherein providing the request to the one or more devices associated with the scene includes determining the one or more devices associated with the scene are connected to the assistant device.

19. The electronic device of claim 17, wherein identifying the user includes a visual recognition algorithm.

20. The electronic device of claim 19, wherein identifying the user includes identifying a user profile.

21. The electronic device of claim 13, wherein the scene trigger includes a combination of user speech and physical gesture.
